(19) United States
(12) Patent Application Publication
(10) Pub. No.: US 2026/0292287 A1
(43) Pub. Date: Sep. 24, 2026

(54) POSE AGGREGATION FOR MULTI-VIEW TEMPORAL VIDEO ALIGNMENT

(71) Applicant: DOLBY LABORATORIES LICENSING CORPORATION, San Francisco, CA (US)

(72) Inventors: Fabien Paul DELATTRE, Cupertino, CA (US); Tsung-Wei HUANG, Sunnyvale, CA (US); Guan-Ming SU, Fremont, CA (US)

(73) Assignee: DOLBY LABORATORIES LICENSING CORPORATION, San Francisco, CA (US)

(21) Appl. No.: 19/569,945

(22) Filed: Mar. 17, 2026

Related U.S. Application Data
(60) Provisional application No. 63/773,869, filed on Mar. 18, 2025.

(51) Int. Cl. H04N 21/43; G06T 5/10; G06T 7/73; G06V 10/74

(52) U.S. Cl. CPC H04N 21/43072; G06T 5/10; G06T 7/73; G06V 10/761

(57) ABSTRACT

A system and method for temporally aligning multiple videos captured from different viewpoints. The system includes a 2D pose extractor that extracts joint coordinates of deformable objects from video frames, a view-invariant pose encoder that generates view-invariant descriptors from the joint coordinates, a frame aggregator that combines multiple descriptors from each frame into a single frame-level descriptor, and a temporal aggregator that incorporates motion information from adjacent frames. The system determines temporal alignment between videos by comparing frame descriptors in the frequency domain using an alignment algorithm. The method supports videos captured from arbitrary viewpoints without requiring metadata or audio information, handles varying numbers of subjects in different frames, operates efficiently through frequency domain processing, and can be extended to align three or more videos while maintaining temporal consistency.

### CROSS-REFERENCE TO RELATED APPLICATIONS

This application claims the benefit of priority from U.S. Provisional Application No. 63/773,869, filed on Mar. 18, 2025, which is incorporated by reference in its entirety.

### BACKGROUND

Recent technological advancements have led to significant societal changes, particularly in the areas of social media and smartphone technology. The improvement in smartphone camera capabilities has democratized video content production, enabling anyone with a device to capture high-quality footage. This has resulted in an unprecedented volume of User-Generated Content (UGC) being shared online, capturing noteworthy events from multiple perspectives.

While this shift from professional productions to amateur footage presents new opportunities, it also introduces several challenges. First, unlike professional productions where camera layouts are carefully planned, amateur footage is often captured from unpredictable and suboptimal angles. Second, videos posted online frequently lack precise temporal information, making it difficult to synchronize different footage of the same event. Finally, the variety of hardware used for recording leads to significant variations in video quality and characteristics.

Traditional approaches to video synchronization have relied on metadata or audio content. However, metadata is often missing, unreliable, or lacks sufficient precision. While audio alignment is well-studied, it fails in scenarios where videos lack audio, don't share common audio features, or have shifted audio due to distance between cameras.

There exists a need for a robust method to synchronize multiple videos of the same event based solely on visual content, particularly for applications such as video mashups and 3D dynamic scene reconstruction.

### SUMMARY

The present disclosure provides systems and methods for temporal synchronization of videos captured from multiple viewpoints. The described approach leverages deformable moving objects, particularly human poses, to align videos temporally without requiring camera parameter information or audio data.

In one aspect, a method for video synchronization includes extracting two-dimensional (2D) or three-dimensional (3D) joints of deformable objects from video frames, generating view-invariant descriptors for the extracted joints, aggregating multiple descriptors from each frame into a single frame-level descriptor, and performing temporal aggregation across adjacent frames to incorporate motion information.

In another aspect, a system for video synchronization includes a 2D or 3D pose extractor, a view-invariant pose encoder, a frame aggregator module, and a temporal aggregator module. The system processes the video frames to generate frame descriptors that can be efficiently compared in the frequency domain or time domain to determine optimal temporal alignment.

The disclosed methods and systems provide several advantages:
Enable temporal synchronization without requiring metadata or audio
Support videos captured from arbitrary viewpoints
Handle varying numbers of subjects in different frames
Operate efficiently through frequency domain processing
Support extension to three or more videos

Applications include video mashups and 3D dynamic scene reconstruction from user-generated content.

These and other features and advantages will be apparent from the following detailed description and accompanying figures.

### BRIEF DESCRIPTION OF THE DRAWINGS

FIG. 1 illustrates example videos captured from different viewpoints that the present system aims to align.

FIG. 2 shows a high-level schema of the video alignment method according to one embodiment.

FIG. 3 illustrates an overview of the method to compute frame descriptors according to one embodiment.

FIG. 4 shows an example of the same pose viewed from two different cameras.

FIG. 5 shows an example of transformer-based view-invariant encoder architecture.

FIG. 6 illustrates the architecture of the projector module according to one embodiment.

FIG. 7 shows a transformer-based temporal aggregation architecture according to one embodiment.

FIG. 8 illustrates an MLP-based temporal aggregation architecture according to one embodiment.

FIG. 9 illustrates alignment of three different views.

### DETAILED DESCRIPTION

The present disclosure provides systems and methods for temporally synchronizing multiple videos captured from different viewpoints. While the description primarily focuses on human subjects as the deformable objects, the techniques are applicable to any type of deformable moving object.

### System Overview

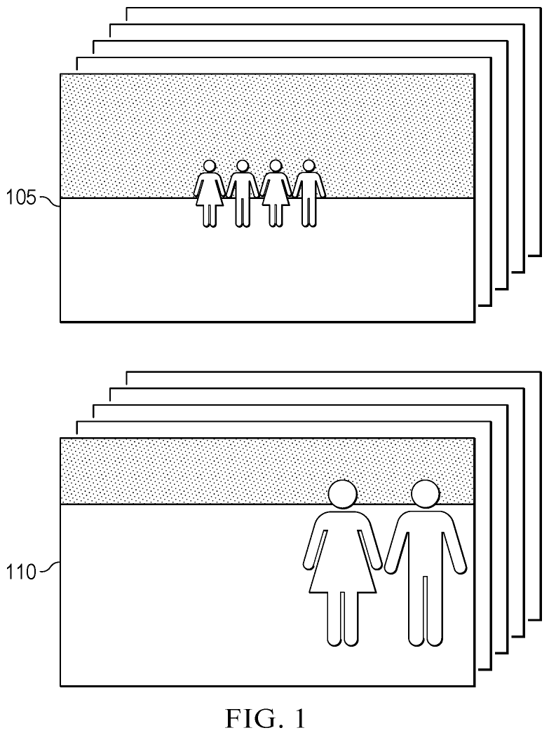

FIG. 1 illustrates example video captured from different viewpoints (105, 110), from different cameras, that demonstrates the challenges addressed by the present invention. As shown, the videos capture the same event but with different focal lengths and perspectives (in this example, a wide shot showing four people (105), and a close shot only showing two of the four (110)), making traditional alignment methods ineffective.

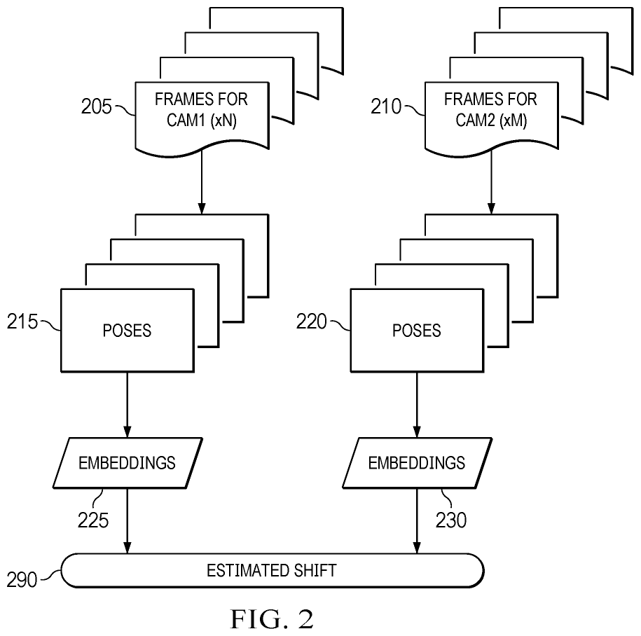

Referring to FIG. 2, a high-level schema of a video alignment system includes several main components: a 2D pose extractor to generate poses (215, 220) for pairs of views (205, 210),a system for determining an embedding vector (225, 230) for each video frame, and a computation of an optimal shift (290) to align the views together. A 3D pose extractor can also be used to generate 3D poses.

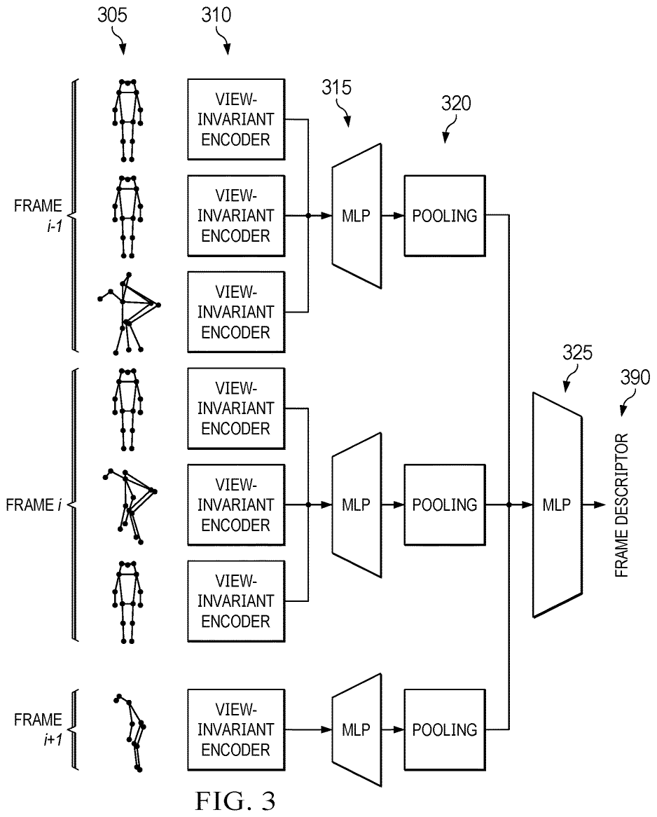

FIG. 3 provides a more detailed view of the system architecture compared to FIG. 2, particularly illustrating the data flow through each component. While FIG. 2 shows the high-level modules, FIG. 3 demonstrates how the data is transformed at each stage, from raw video frames to final frame descriptors. The result of this pipeline is a sequence of frame descriptors for each video. The shift that maximizes the similarity between two sequences of frame descriptor can be efficiently computed in the frequency domain.

The method uses the presence of deformable moving objects to temporally synchronize videos taken from multiple views. The examples herein focus on humans, but the method is general and can be used for any sort of deformable moving objects (i.e. anything than can be decomposed into poses). The method is generally described as follows: first extract the joints (305), then pass the joints into a view-invariant encoder (310) that outputs a view-invariant descriptor for each pose. Then project those view-invariant descriptors in a high dimension space (315) before aggregating/pooling (320) all the pose descriptors from a same frame in a single frame-level descriptor. Finally, aggregate (325) frame descriptors from the nearby frames to geta final frame descriptor (390) that also encodes motion information. The method is trainable end to end, but pretrained models can also be used for extracting 2D joints and for the view-invariant encoder.

### 2D Pose Extraction

The 2D pose extractor processes input video frames to identify and extract the coordinates of key joints of deformable objects. For human subjects, the system can, for example, use thirteen key points: left hip, right hip, left knee, right knee, left ankle, right ankle, nose tip, left shoulder, right shoulder, left elbow, right elbow, left wrist, and right wrist. Generally, fewer key points can be used for lower complexity and more key points can be used for higher accuracy.

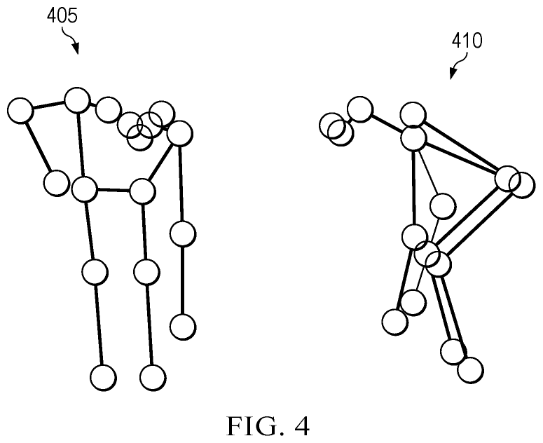

FIG. 4 illustrates the challenge addressed by the view-invariant encoding, showing the same pose viewed from two different camera angles (405, 410). Traditional 2D coordinate comparison (finding the rigid transforms to solve the orthogonal Procrustes problem) is too computationally expensive, so view-invariant encoding is used.

### View-Invariant Pose Encoding

The view-invariant pose encoder converts the extracted 2D joint coordinates into view-invariant descriptors. This encoding ensures that the same pose viewed from different angles produces similar descriptors, enabling comparison across different camera viewpoints. In some embodiments, this is performed by a transformer-based encoder.

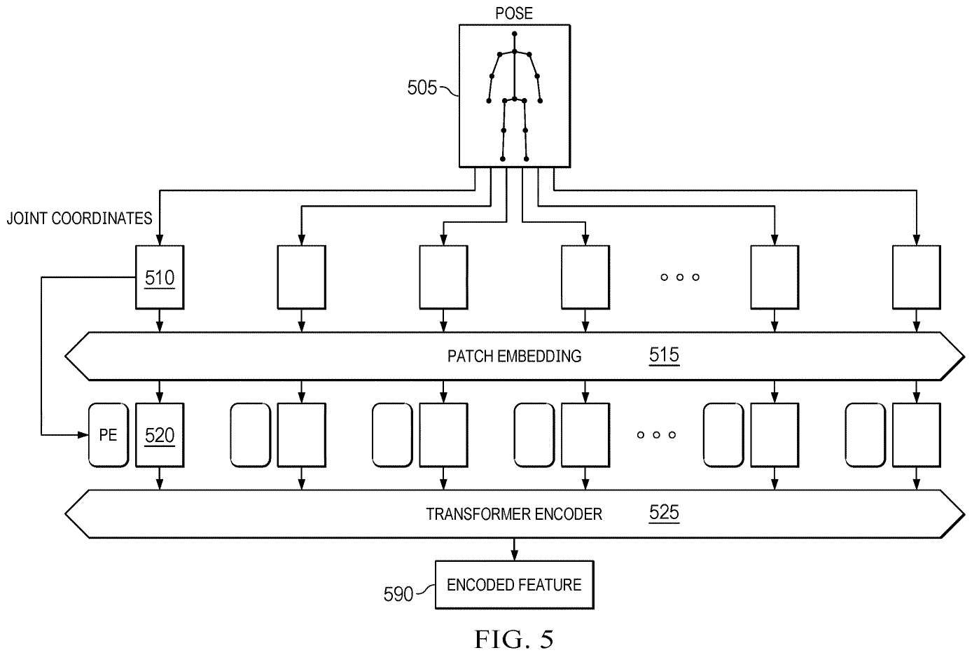

FIG. 5 shows an example of a transformer-based view-invariant encoder. The 2D pose (505) takes the coordinates of each joint (510) and runs them through a patch embedding layer (515) to map the coordinates to spatial position embedding vectors (520). A transformer encoder layer (525) then extracts a feature (590) from the vectors (520).

In contrast to the basic 2D pose extraction, the encoder generates 32-dimensional embedding vectors for each detected pose. These embeddings are designed to be invariant to viewpoint changes while preserving pose-specific information. A 3D pose extraction would be similar to the 2D system, but with an added z coordinate for the joints.

### Aggregation

At this stage of the pipeline, there is one view-invariant embedding per human. In other words, for each frame there is a variable size unordered set of embeddings. In embodiments herein, the next step of the method is to combine those embedding vectors into a single fixed-size descriptor per frame, known as “aggregation”.

More formally, for the i-th frame of video A:

$${\overline{A}}_{i} = g ( {A}_{i} )$$

where g is the frame aggregator,

$${A}_{i} = \{ {A}_{i}^{j} \vert 1 \leq j \leq \vert {A}_{i} \vert \}$$

is we set of all the view-invariant pose descriptors in the frame from previous section, and Āᵢ ∈ [symbol] is the d_{f}-dimensional frame descriptor. In some embodiments, d_{f} is a value from 256 to 1024.

### Pooling-Based Aggregation

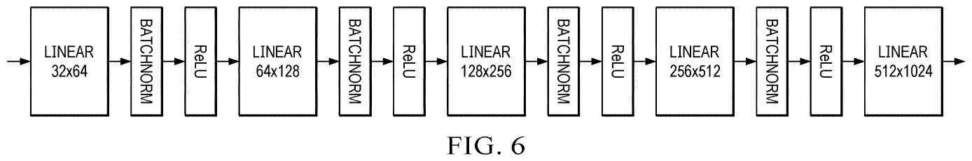

FIG. 6 illustrates an example architecture of the projector in the frame aggregator, which projects the view-invariant pose representation in a higher dimensional space and then pools the representation across the skeletons present in a same frame.

As depicted in FIG. 6, the projector comprises a sequence of four “Linear-Batch normalization-ReLU” units, where the corresponding linear blocks in each unit are 32×64, 64×128, 128×256, and 256×512, and terminates with a linear 512×1024 block. As used herein, the term “Linear M×N” denotes a linear block with input dimension M and output dimension N. A linear layer denotes a standard linear layer (e.g., y=Ax+b). The architecture allows the projector to project a batch of 1D vectors of frame descriptors (∈ [symbol] ) from a 32-diomensional space to a 1024-dimensional space. Technically, the network architecture of the projector may also be considered an MLP.

More formally, for each view-invariant pose descriptor Aᵢ^{j} in Aᵢ:

$$\tilde{{A}_{l}^{J}} = h ( {A}_{i}^{j} )$$

where h: [symbol] → [symbol] is the projector, Ãᵢ^{j} ∈ [symbol] is the projected view-invariant pose descriptor, and d_{f} is the dimension after projection.

The aggregator employs softmax pooling to combine multiple descriptors, using a temperature parameter τ to control the balance between maximum and average pooling behaviors. This approach provides more flexibility compared to traditional max pooling methods.

This allows the gradient to flow back in all skeletons and not just the maximum one. τ is the temperature parameter. As τ tends to zero the pooling is in a maximized behavior, and when τ tends to infinity it tends to an average behavior. Example values for z range from 0.01 to 100. Let pᵢ^{j} be the i^{th} component of the j^{th} descriptor and p ∈ [symbol] .

$$soft Max Pool ( p ) = [ soft Max Pool ( {p}_{1} ) , … , soft Max Pool ( {p}_{D} ) ]$$

$$soft Max Pool ( {p}_{i} ) = {\sum }_{1 \leq j \leq N} {p}_{i}^{j} \frac{{e}^{\frac{{p}_{i}^{j}}{τ}}}{{Σ}_{1 \leq k \leq N} {e}^{\frac{{p}_{i}^{k}}{τ}}}$$

Finally, the calculation of frame descriptor can be represented as follow.

$${\overline{A}}_{i} = s oft Max Pool ( {\tilde{A}}_{ι} )$$

Here Ãᵢ ∈ [symbol] is the 2D array of concatenation of projected descriptors Ãᵢ^{j} for all 1≤j≤|Aᵢ|. See also the section on Multiple Video Alignment below for a computation on just a portion of the embeddings (e.g. p(u, v) and p_{soft} (u, v)). Alternatively, a standard maximum can be used instead of a softmax.

### Temporal Aggregation

At this point of the pipeline, there is one descriptor per frame. While one could directly use those descriptors to align the videos, those descriptors only capture the instantaneous poses and do not contain any motion information. In some embodiments, aggregation of multiple frame descriptors from different timesteps is incorporated into the final descriptor to leverage motion information.

More formally,

$${a}_{i} = f ( {\overline{A}}_{i - T} , {\overline{A}}_{i - T + 1} , … , {\overline{A}}_{i} , … , {\overline{A}}_{i + T} )$$

where f is the temporal aggregator module, Ā_{i-T}, Ā_{i-T+1}, . . . , Āᵢ, . . . , Ā_{i+T} are the 2T+1 frame descriptors previously described, and aᵢ ∈ [symbol] is the temporally aggregated frame descriptor. In an example embodiment, use T=1 to aggregate 3 frame descriptors into one final descriptor.

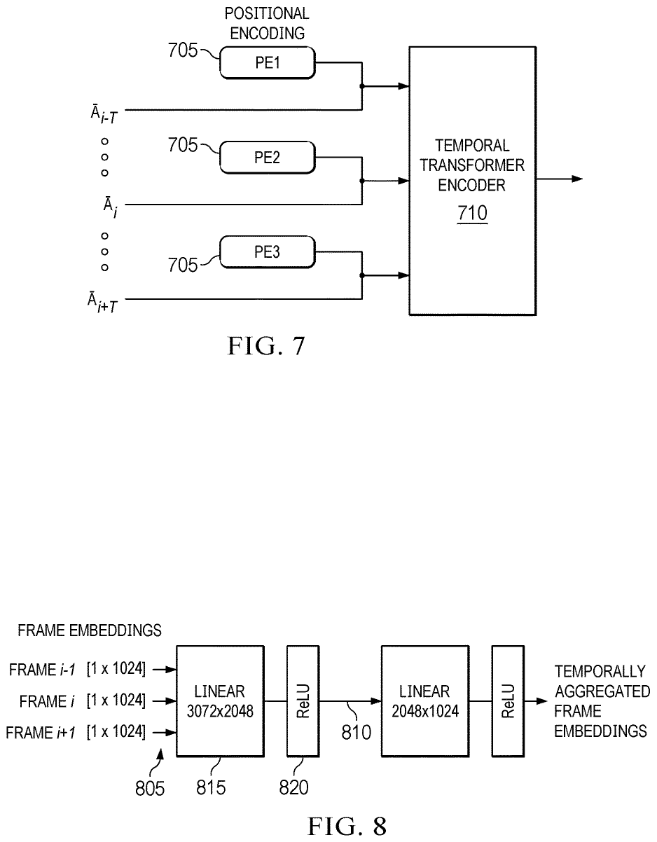

The system provides two distinct implementations of the temporal aggregator, each suited for different scenarios. FIG. 7 shows a transformer-based architecture that processes multiple frames simultaneously, while FIG. 8 illustrates a more computationally efficient MLP-based architecture.

The transformer-based architecture shown in FIG. 7 includes positional encoding (PE) (705) and a multiple transformer layers encoder (710), enabling the system to capture complex temporal relationships.

In contrast, the MLP-based (where MLP stands for multilayer perceptron) architecture of FIG. 8 uses a simpler structure with concatenation (805) and feed-forward layers (810), making it more suitable for processing a smaller number of adjacent frames. In the case there are frames without any humans (nothing to extract pose information from), the embeddings of such frames will be the null vectors. In some embodiments, the similarity function is defined to be zero, meaning there is no evidence that those two frames captured the same moment. Similarly, if two views captured different poses, this means there is no positive evidence, but it doesn't mean there is negative evidence. Therefore, each network (815) ends with a ReLU (820) (rectified linear unit) activation to force all the components of the embeddings to be positive so that the dot products between the frame embeddings are all positive or null.

### Attention-Based Aggregation

When there are many human figures in the video, the cross-attention blocks of Bag of Queries based aggregation (see Ali-bey, Amar, Brahim Chaib-draa and Philippe Giguere. “BoQ: A Place is Worth a Bag of Learnable Queries.” ArXiv abs/2405.07364 (2024)) can effectively fuse the useful information from multiple input embeddings. However, it is less efficient for lower number of humans than the other aggregation methods described herein.

### Similarity Computation

Given two 1D frame descriptors, the measurement of similarity between them can be determined using cosine similarity. Given two frame descriptors aᵢ, bₗ ∈ [symbol] from the i-th frame of video A and l-th frame of video B, respectively, their cosine similarity is defined as:

$$s ( {a}_{i} , {b}_{l} ) = \frac{{a}_{i} \cdot {b}_{l}}{\vert {a}_{i} \vert \vert {b}_{l} \vert}$$

Where s(aᵢ, bₗ) is a scalar. This is value is used in alignment, as described below.

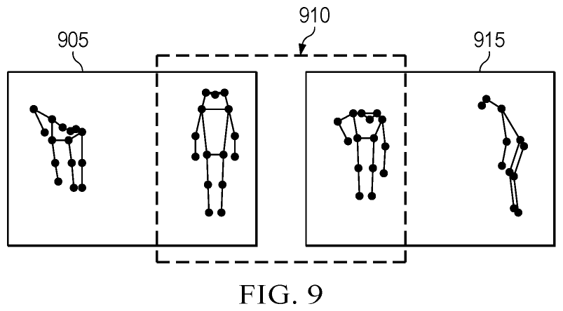

In embodiments that offer the model a way to provide similarity measure on partially similar frames, non-linearity is introduced after the computation of cosine similarity. Instead of computing the cosine similarity on the whole representation of vectors, some embodiments just compute the cosine similarity on part of the embeddings and take the max. The advantage of such non-linearity is illustrated in the example in FIG. 9. The view A (905) and B (910), sharing one pose should have similar representation. Similarly, the views B (910) and C (915) should also have similar representation. However, the views A (905) and C (915) should be distinct since they do not share any similar poses.

More formally, split the representation vector u into n parts u₁, u₂, . . . , uₙ where uᵢ ∈ [symbol] n|D, (i.e., n divides D).

$$p ( u , v ) = {max}_{1 \leq i \leq n} s ( {u}_{i} , {v}_{i} )$$

The previous formulation would imply the gradient only flow in the i^{th} component winner, so a softmax version can also be used:

$${p}_{soft} ( u , v ) = {\sum }_{1 \leq i \leq n} s ( {u}_{i} , {v}_{i} ) \frac{{e}^{\frac{s ( {u}_{i} , {v}_{i} )}{τ}}}{{Σ}_{1 \leq j \leq n} {e}^{\frac{s ( {u}_{j} , {v}_{j} )}{τ}}}$$

where τ is the temperature parameter and p_{soft} is the similarity by parts. When τ tends to infinity, p_{soft} (u, v) tends to simply be the average while when τ tends to zero, p_{soft} (u, v) tends to be the max.

### Alignment Computation

Given two sequences of frame descriptors for videos A and B where a=[a₁, a₂, . . . , a_{N}]∈ [symbol] and b=[b₁, b₂, . . . , bₙ]∈ [symbol] the relative shift of b can be found such that a and b are aligned. N and M are the number of frames in videos A and B, respectively, and D is the dimension of the final descriptor. With the assumption that there is at least one frame of overlap between a and b, there are (N+M−1) possible shifts.

Given a hypothesis shift δ, compute the similarity s between the two sequences using

$${s}_{δ} ( a , b ) = {\sum }_{t = - ∞}^{∞} {a}_{t} {b}_{t + δ} .$$

Rearranging the above equation to sum over the components of the descriptors last gives

$${s}_{δ} ( a , b ) = {\sum }_{d = 1}^{D} {\sum }_{t = - ∞}^{∞} {a}_{t , d} {b}_{t + δ , d} .$$

Where d is a dimension in D. This can be computed for all values of δ using convolutions

$$s ( a , b ) = [ ⋯ , {s}_{0} ( a , b ) , {s}_{1} ( a , b ) , ⋯ ] = {\sum }_{d = 1}^{D} {a}_{, d} ⊗ {b}_{, d} .$$

where ⊗ is the convolution operation. The notation “,d” refers to slices of a and b in the d-th feature dimension.

Applying the convolution theorem gives

$$s ( a , b ) = {\sum }_{d = I}^{D} {F}^{- 1} ( \overline{F ( {a}_{, d} )} F ( {b}_{, d} ) ) .$$

where F is the 1D-discrete Fourier transform and F⁻¹ its inverse. The bar notation indicates a complex conjugate. Using the linearity of the Fourier operator, it can be re-written as:

$$s ( a , b ) = {F}^{- 1} ( {\sum }_{d = 1}^{D} \overline{F ( {a}_{, d} )} F ( {b}_{, d} ) )$$

where s(a, b) is a vector of length (N+M−1). The shift that maximizes the similarity between the two sequences of descriptors is given by the index of the maximum value in s(a, b). Below is example pseudo-code for the alignment algorithm, which operates in the frequency domain for computational efficiency. For example, finding two sequences of length 1000 with 256 dimensional embeddings takes 0.03 s in Python.

### Algorithm for Optimal Alignment

Input:
vid1: Sequence of frame descriptors of shape, (N, D)
vid2: Sequence of frame descriptors of shape, (M, D)

Output:
bestShift: Estimated shift, int
   vid1←pad(vid1) #Zero padding to shape (N+M−1, D)
   vid2←pad(vid2)
   vid1Freq←FFT(vid1, axis=0) #Fast Fourier Transform
   vid2Freq←FFT(vid2, axis=0)
   crosCorr←vid1Freq*conj(vid2Freq)
   crosCorr←sum(crosCorr, axis=1)
   crosCorr←IFFT(crosCorr) #Inverse Fast Fourier Transform
   bestShift←argmax(corsCorr)

The temporal complexity of the alignment module is O((N+M)log(N+M)). N and Mare the lengths of the input videos vid1 and vid2 respectively. The complexity of the 2D pose extractor module, the view-invariant module and the frame aggregator module are all O(N [symbol] [|A|]+M [symbol] [|B|]). The complexity of the Temporal aggregator module is O(N+M). Therefore, the complexity of the method described above is O((N+M)log(N+M)+N [symbol] [|A|]+M [symbol] [|B|]), which is much smaller than the complexity of a “Brute force” baseline which is O(N [symbol] [|A|]M [symbol] [|B|]).

Herein, “brute force” refers to a baseline for video alignment techniques where the cosine similarity of all possible pairs of embeddings is computed, e.g.:

Given a video A of length N, denote |A₁| the number of people present on the i-th frame of the video A with 1≤i≤N. Then denote Aᵢ^{j} ∈ [symbol] the dₚ-dimensional embedding vector for the j-th person on the i-th frame of video A with 1≤j≤|Aᵢ|, and Aᵢ={Aᵢ^{j} |1≤j≤|Aᵢ|} the set of all embeddings in the i-th frame. For example, use dₚ=32. Now let B be a second video of length M. Similarly, have Bₗ^{k} ∈ [symbol] the dₚ-dimensional embedding vector for the k-th person on the l-th frame of video B with 1≤k≤|Bₗ|, and Bₗ={Bₗ^{k}|1≤k≤|Bₗ|} as the set of all embeddings in the i-th frame. Then compute the cosine similarity between all possible pairs of embeddings:

$$s ( {A}_{i}^{j} , {B}_{l}^{k} ) = \frac{{A}_{i}^{j} \cdot {B}_{l}^{k}}{\vert {A}_{i}^{j} \vert \vert {B}_{l}^{k} \vert}$$

for all 1≤i≤N, 1≤j≤|Aᵢ|, 1≤l≤M and 1≤k≤|Bₗ|. i.e. compute the similarity between all people in video A and all people in video B. Each similarity computation is associated with a shift t=i−l. Therefore, there are N+M−1 different possible shifts, i.e., 1−M≤t≤N−1, so that there is at least a 1 frame overlap between the two videos. create a list of priority queues P of length N+M−1 where P[t] is the priority queue keeping the top K similarities for shift t. Populate the priority queue P[t] with all the

$$s ( {A}_{i}^{j} , {B}_{l}^{k} )$$

where t=i−l. For example, set K to 100. While this baseline showed strong performance and validated our choice of using human poses and view-invariant embedding to perform the video alignment, this “Brute Force” baseline is extremely inefficient in terms of numbers of comparison. Let [symbol] [|A|] and [symbol] [|B|] respectively the average number of people per frame for video A and B. The “Brute Force” method requires N [symbol] [|A|]M [symbol] [|B|] comparisons.

### Training

In some embodiments, the model can be trained in a contrastive learning fashion where the positive pairs are synchronized views from different viewpoints and negative pairs are non-synchronized views. For example, the loss (l_{i,j}) can be determined by a contrastive loss function like InfoNCE (Noise-Contrastive Estimation, see Oord, Aaron van den, Yazhe Li and Oriol Vinyals “Representation Learning with Contrastive Predictive Coding.” ArXiv abs/1807.03748 (2018)) and a contrastive training scheme like SimCLR (see Chen, Ting, Simon Kornblith, Mohammad Norouzi and Geoffrey E. Hinton “A Simple Framework for Contrastive Learning of Visual Representations.” ArXiv abs/2002.05709 (2020)).

$${l}_{i , j} = - log \frac{exp ( s i m ( {a}_{i} , {a}_{j} ) / τ )}{{Σ}_{k = 1}^{2 N} {𝕀}_{[ k \neq i ]} exp ( s i m ( {a}_{i} , {a}_{k} ) / τ )}$$

where [symbol] [k≠i]∈ {0,1} is an indicator function evaluating to 1 iff k≠i, and τ denotes a temperature parameter. The function

$$s i m ( u , v ) = \frac{{u}^{T} v}{‖ u ‖ ‖ v ‖}$$

denotes the dot product between L2 normalized u and v (i.e. cosine similarity.)

InfoNCE can be seen as classifying the example aᵢ into the classes {aₖ|1≤k≤2M, k≠i} where a₁ is the correct class. The pair (aᵢ, aⱼ) is called the positive pair, while the pairs (aᵢ, aₖ) with k≠j are called the negative pairs. Given the ground truth shift δ* for the videos a and b, so that a[i] and b[i+δ*] are frames taken at the same time, therefore j=i+δ*. The logits are similarity measurements, in our case cosine similarity. This has the effect of increasing the similarity between positive pairs and decreasing the similarity between negative pairs. InfoNCE has one hyper-parameter T called the temperature which control the entropy of the distribution. In some embodiments, set T between 0.01 and 100 (e.g. 0.07).

The learnable parameters of this method are in the 2D pose extraction module, the view-invariant pose encoder module, the frame aggregator module and the temporal aggregator module. In some embodiments, the entire pipeline is trained end-to-end. However, when training data is limited or fast training is needed, some embodiments can freeze the 2D pose extraction module and the view-invariant pose encoder module and only train the frame aggregator and temporal aggregator modules.

### Multiple Video Alignment

In another embodiment, the pairwise alignment can be extended to three or more views. Given multiple videos, one first runs the proposed method for some pairs of videos, and then apply the method by Douze et al. (Ref. [1]) for proper post alignment. In some embodiments, multiple views (any number) are aligned. Given a set of N videos V: {V₁, V₂, . . . , V_{N}} (having either the same framerate to start with, or the framerates are normalized), find N−1 offsets such that all videos can be placed on a common timeline. As an example, for V:{A, B, C, D, E, F}, for each pair of videos (e.g. {A, B}, {B, C}, {A, C}, etc.) compute the offset δᵢⱼ (start time of video j in video i, for pair {i, j}). Then find the largest subset of video pairs that is compatible with a common timeline for a given tolerance e. See Douze et al. (Ref [1]).

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

### REFERENCES

[1] Matthijs Douze, Jérôme Revaud, Jakob J. Verbeek, Herve Jegou, and Cordelia Schmid “Circulant Temporal Encoding for Video Retrieval and Temporal Alignment.” International Journal of Computer Vision, 119 (2015): 291-306.

1. A method for temporally aligning multiple videos, comprising:
extracting, using a pose extractor, joint coordinates of deformable objects from frames of multiple input videos;
generating, using a view-invariant pose encoder, view-invariant descriptors from the extracted joint coordinates;
aggregating, using a frame aggregator, multiple view-invariant descriptors from each frame into a single frame-level descriptor;
performing temporal aggregation, using a temporal aggregator, across adjacent frames to generate temporally-aware frame descriptors; and
determining temporal alignment between videos by comparing the temporally-aware frame descriptors using an alignment algorithm.

2. The method of claim 1, wherein generating view-invariant descriptors comprises:
processing the joint coordinates through the view-invariant pose encoder to generate fixed-dimension embedding vectors that are invariant to viewpoint changes.

3. The method of claim 1, wherein aggregating multiple view-invariant descriptors comprises:
projecting the view-invariant descriptors using a projector component to a higher-dimensional space; and
applying softmax pooling using a pooling layer to combine multiple descriptors into a single frame-level descriptor.

4. The method of claim 3, wherein the softmax pooling uses a temperature parameter to control a balance between maximum and average pooling behaviors.

5. The method of claim 1, wherein performing temporal aggregation comprises:
processing descriptors from multiple adjacent frames through either a transformer-based architecture or an MLP-based architecture to generate temporally-aware frame descriptors.

6. The method of claim 1, wherein determining temporal alignment comprises:
computing cross-correlation between frame descriptor sequences in the frequency domain using Fast Fourier Transform (FFT) or in the time domain; and
identifying the temporal shift that maximizes similarity between the sequences.

7. The method of claim 1, wherein determining similarity between frame descriptors comprises:
cosine similarity; or
similarity by parts.

8. The method of claim 1, wherein the pose extractor is a 2D or 3D pose extractor, and the joint coordinates are 2D or 3D coordinates.

9. A system (100) for video alignment, comprising:
a pose extractor configured to identify and extract joint coordinates from video frames;
a view-invariant encoder configured to generate pose descriptors that are invariant to viewpoint changes;
a frame aggregator configured to combine multiple pose descriptors into single frame-level descriptors; and
a temporal aggregator configured to incorporate motion information from adjacent frames.

10. The system of claim 9, wherein the frame aggregator comprises:
a projector component that maps pose descriptors to a higher-dimensional space; and
a pooling layer that combines multiple projected descriptors into a single frame descriptor.

11. The system of claim 9, wherein the temporal aggregator implements either:
a transformer-based architecture for processing multiple frames simultaneously; or
an MLP-based architecture for processing a smaller number of adjacent frames.

12. The system of claim 9, further comprising:
an alignment module configured to compute temporal alignment between videos by comparing frame descriptors in the frequency domain using the alignment algorithm.

13. A non-transitory computer-readable medium storing instructions that, when executed by a processor, cause the processor to:
extract pose information using a pose extractor from multiple videos;
generate view-invariant descriptors for the extracted poses using a view-invariant encoder;
aggregate pose descriptors into frame-level descriptors using a frame aggregator;
combine information from adjacent frames using a temporal aggregator; and
determine temporal alignment between the videos using frequency domain or time domain analysis.

14. A method of training a video alignment system, comprising:
providing pairs of synchronized video frames from different viewpoints as positive training examples;
providing non-synchronized video frames as negative training examples; and
training the system using contrastive learning with an InfoNCE loss function.

15. The method of claim 14, further comprising:
freezing weights of pre-trained pose extraction and view-invariant encoding modules; and
training only frame aggregation and temporal aggregation modules.

16. The method of claim 1, wherein the deformable objects comprise human figures, and the joint coordinates correspond to human body joints.

17. The method of claim 1, further comprising:
extending the alignment to three or more videos by maintaining consistency across pairwise alignments.
